(19) United States
(12) Patent Application Publication
(10) Pub. No.: US 2007/0190352 A1
(43) Pub. Date: Aug. 16, 2007

(54) Wear protection coating for a gas turbine component

(76) Inventors: Erwin Bayer, Dachau (DE); Wilfried Smarsly, Muenchen (DE); Juergen Steinwandel, Uhldingen-Muehlhofen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/572,770

(22) PCT Filed: Aug. 26, 2004
(86) PCT No.: PCT/DE04/01882

§ 371 Date: Jan. 3, 2007

(30) Foreign Application Priority Data
Sep. 22, 2003 (DE) 103 43 761.4

(51) Int. Cl. B32B 15/00; C25D 5/10

(52) U.S. Cl. 428/627; 428/660; 427/402; 427/372.2; 427/430.1; 427/421.1; 427/248.1

(57) ABSTRACT

A wear protection coating, in particular an erosion protection coating for gas turbine components is disclosed. The wear protection coating is applied to a to-be-protected surface of a flow mechanically stressed component. The wear protection coating has an at least double-layer structure, where a first layer is applied to the to-be-protected surface of the component and has a material composition that is adapted to the material composition of the component and where a second layer forms an outer cover coat.

This application claims the priority of International Application No. PCT/DE2004/001882, filed Aug. 26, 2004, and German Patent Document No. 103 43 761.4, filed Sep. 22, 2003, the disclosures of which are expressly incorporated by reference herein.

### BACKGROUND AND SUMMARY OF THE INVENTION

The invention relates to a wear protection coating, in particular an erosion protection layer for gas turbine components. In addition, the invention relates to a component with this type of wear protection coating and a method to manufacture a wear protection coating.

Components that are flow mechanically stressed, such gas turbine components, are subject to wear from oxidation, corrosion and erosion. Erosion is a wear process, which is caused by solid matter that is also being conveyed in the gas flow. In order to lengthen the service life of components that are flow mechanically stressed, wear protection coatings are required that protect the component from wear, in particular from erosion, corrosion and oxidation.

A wear protection coating for flow mechanically stressed components is known from German Patent Document No. DE 198 59 477 A1. The wear protection coating disclosed in this document is comprised essentially of amorphous or amorphous-nanocrystalline metals, in particular of an alloy with a nickel-tungsten basis.

Starting from this, the invention at hand is based on the objective of creating a novel wear protection coating, in particular for gas turbine components, as well as a component with this type of wear protection coating and a corresponding manufacturing method.

The wear protection coating in accordance with the invention has an at least double-layer structure, wherein a first layer is applied to the to-be-protected surface of the component and has a material composition that is adapted to the material composition of the component, and wherein a second layer forms an outer cover coat.

The first layer is embodied preferably as a porous, relatively soft layer with damping properties, whereas the second layer is embodied as a relatively hard layer. The outer, second layer produces the actual erosion protection. The damping first layer that is beneath can absorb energy in the case of impact and thereby prevent the formation of cracks in the component being protected.

Preferred developments of the invention are yielded in the following description.

### BRIEF DESCRIPTION OF THE DRAWINGS

Without being limited thereto, exemplary embodiments of the invention are explained in more detail in the drawings. The drawings show:

FIG. 1 is a very schematic representation of a blade of a gas turbine featuring the wear protection coating in accordance with the invention, and

FIG. 2 is a very schematic cross section through the wear protection coating in accordance with the invention.

### DETAILED DESCRIPTION OF THE DRAWINGS

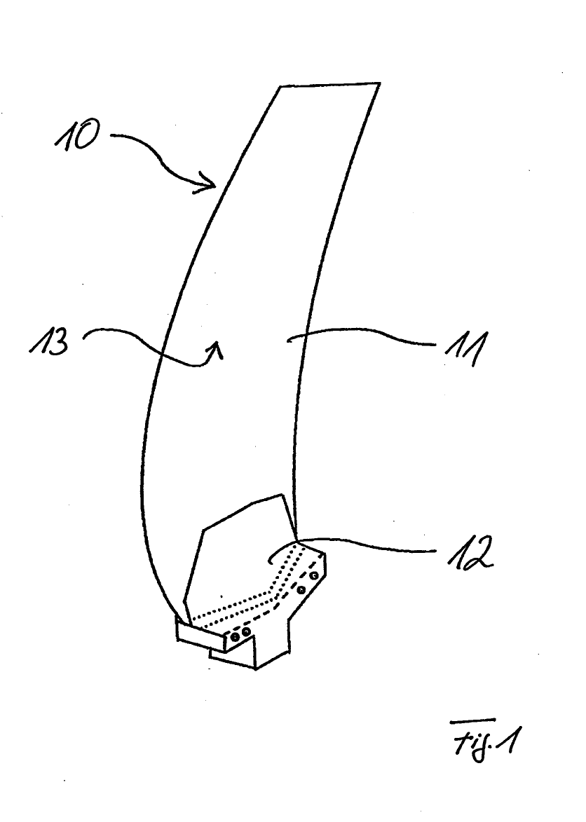

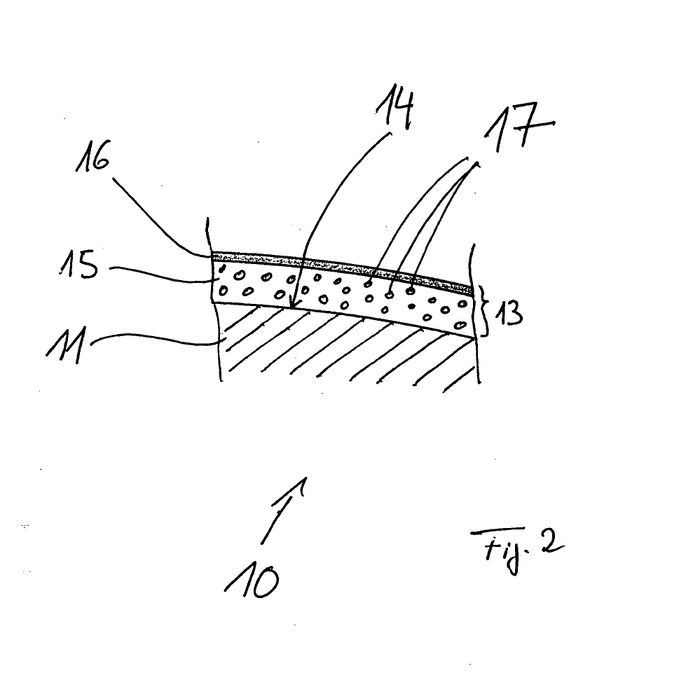

In the following, the invention at hand shall be explained in greater detail making reference to FIGS. 1 and 2. FIG. 1 shows a perspective view of the blade of a gas turbine bearing the wear protection coating in accordance with the invention. FIG. 2 shows a schematic cross section through the blade and the wear protection coating.

FIG. 1 shows a blade 10 of a gas turbine with a blade pan 11 and a blade footing 12. In the exemplary embodiment in FIG. 1, the entire blade 10, namely a to-be-protected surface of the blade, is coated with a wear protection coating 13. Although the entire blade 10 is coated with the wear protection coating 13 in the depicted exemplary embodiment, it is also possible for the blade 10 to have the wear protection coating 13 only in sections, i.e., only in the area of the blade pan 11 or in the area of the blade footing 12. In addition, other gas turbine components such as rotors with integrally mounted blades can be coated with the wear protection coating 13.

FIG. 2 shows a cross section through the blade 10 in the area of the blade pan 11, wherein the wear protection coating 13 is applied to one surface 14 of the blade pan 11. Within the spirit of the invention, the wear protection coating 13, which forms an erosion protection coating in the exemplary embodiment shown, is structured to be at least double-layered or double-ply. In the concrete exemplary embodiment in FIG. 2, the wear protection coating 13 is comprised of two layers. A first layer 15 is applied directly to the surface 14 of the blade pan 11. A second layer 16 forms an outer cover coat of the wear protection coating 13 and is applied directly to the first layer 15.

It is within the spirit of the present invention to manufacture the first layer 15 from a material, which is adapted to the material composition of the to-be-coated component, which in the depicted exemplary embodiment is adapted to the material composition of the blade 10 or the blade pan 11. If the to-be-coated component, namely the blade pan 11, is composed of a titanium alloy, then the first layer 15 of the wear protection coating 13 is also formed of a titanium alloy. In the depicted exemplary embodiment, the blade pan is formed of a titanium-aluminum material and the first layer 15 of the wear protection coating 13 is also composed of a titanium-aluminum material. However, the first layer 15 of the wear protection coating 13 is embodied to be porous and relatively soft as compared to the to-be-coated component, namely the to-be-coated blade pan 11. Pores 17 within the first layer 15 of the wear protection coating 13 are depicted very schematically in FIG. 2. The porous as well as relatively soft first layer 15 has damping properties.

The second layer 16 that is applied to the first layer 15 is embodied to be relatively hard as compared to the first layer 15 as well as in comparison to the to-be-coated component, namely the to-be-coated blade pan 11. In the case of a component made of a titanium-aluminum material and a first layer made of a porous titanium-aluminum material, the second layer 16 of the wear protection coating 13 is preferably made of a titanium-nitride material, an aluminum-nitride material or a titanium-aluminum-nitride material.

The second layer 16, which forms the cover coat of the wear protection coating 13, is embodied to be relatively thin as compared to the first layer 15. The outer, second layer 16 preferably has a thickness of less than 0.1 mm. The inner first layer 15 has a thickness of up to 1 mm.

The relatively hard, outer second layer 16 provides the actual erosion protection of the wear protection coating 13. The second layer 16 protects the blade pan 11 from erosion from fine particles. The first layer 15 beneath it, which is embodied to be porous and relatively soft, has damping properties so that it can absorb energy from the impact of larger particles on the wear protection coating 13. In the case of an impact from large particles, the fine, round and microscopically small pores 17 within the first layer 15 of the wear protection coating 13 prevent a crack of the relatively hard outer layer 16 from being able to continue into the to-be-protected component, namely the to-be-protected blade pan 11. In this respect, the wear protection coating 13 in accordance with the invention represents effective protection against wear from erosion.

Because the first layer 15 of the wear protection coating 13 is composed of a similar or the same material as the component being protected, thermally induced internal stress or diffusion problems are avoided on the component being protected. The wear protection coating 13 can therefore be applied safely and lastingly to the component being protected.

The wear protection coating 13 in accordance with the invention is applied in layers on the component being protected. To begin with, the first layer 15 is applied to the component being protected, which has a component material composition, followed by the second layer 16 of the wear protection coating 13. As already mentioned, the first layer 15 of the wear protection coating 13 has a material composition adapted to the material composition of the component and is embodied as a porous layer.

According to a preferred embodiment of the method in accordance with the invention, the first layer 15 of the wear protection coating 13 is applied to the to-be-protected surface of the component via a targeted, atomic or nanoscale particle beam or matter vapor beam. In particular, a PVD method (Physical Vapor Deposition) is used for this. Shortly before the impact of the targeted matter vapor beam, additives are incorporated into the matter vapor beam, which vaporize during the subsequent hardening of the first layer 15 and leave behind pores 17 in the process. The additives are preferably embodied as fullerenes. However, other additives can also be used instead of the fullerenes, which vaporize during hardening or stove-enameling of the first layer 15 and leave the pores 17 behind.

At this point it must be noted that the first layer 15 can also be applied to the to-be-protected surface of the component with the aid of a slip method. In this case, a slip material whose composition is adapted to the material composition of the component being protected is applied to the component being protected via daubing, dipping or spraying. Additives are incorporated in turn into this slip material, which vaporize during hardening of the first layer and leave behind pores.

Finally, the second layer 16 is applied to the first layer 15. In the exemplary embodiment shown, in which the wear protection coating 13 is embodied to be double-layered, the second layer 16 is applied directly to the first layer 15. This is accomplished preferably by evaporation coating, nitration, aluminizing or oxidizing.

1-19. (canceled)

20. A wear protection coating, in particular an erosion protection coating for gas turbine components, which is applied to a to-be-protected surface of a flow mechanically stressed component, comprising an at least double-layer structure, wherein a first layer is applied to the to-be-protected surface of the component and has a material composition that is adapted to a material composition of the component, and wherein a second layer forms an outer cover coat.

21. The wear protection coating according to claim 20, wherein the first layer of the wear protection coating is comprised of a same or a similar material as the component.

22. The wear protection coating according to claim 20, wherein the first layer is porous and relatively soft.

23. The wear protection coating according to claim 20, wherein the first layer has damping properties.

24. The wear protection coating according to claim 20, wherein the first layer is applied directly to the to-be-protected surface of the component.

25. The wear protection coating according to claim 20, wherein the component is comprised of a titanium alloy and the first layer is comprised of a porous titanium alloy and wherein the component is a blade of a gas turbine.

26. The wear protection coating according to claim 20, wherein the component is comprised of a titanium-aluminum material and the first layer is comprised of a porous titanium-aluminum material.

27. The wear protection coating according to claim 20, wherein the second layer of the wear protection coating is relatively hard.

28. The wear protection coating according to claim 20, wherein the second layer is applied directly to the first layer.

29. The wear protection coating according to claim 20, wherein the second layer is comprised of a titanium-nitride material, an aluminum-nitride material or a titanium-aluminum-nitride material.

30. A component, in particular a gas turbine component, with a wear protection coating, in particular with an erosion protection coating, which is applied to a to-be-protected surface of a flow mechanically stressed component, wherein the wear protection coating has an at least double-layer structure, wherein a first layer is applied to the to-be-protected surface of the component and has a material composition that is adapted to a material composition of the component, and wherein a second layer forms an outer cover coat.

31. A method to manufacture a wear protection coating, in particular an erosion protection coating for gas turbine components, which is applied to a to-be-protected surface of a flow mechanically stressed component, comprising the steps of:
a) making available the component comprised of a component material composition; and
b) applying the wear protection coating to the to-be-protected surface of the component, wherein the wear protection coating has an at least double-layer structure, wherein a first layer is applied to the to-be-protected surface of the component and has a material composition that is adapted to a material composition of the component, and wherein a second layer forms an outer cover coat.

32. The method according to claim 31, wherein the first layer is applied directly to the to-be-protected surface of the component as a porous layer.

33. The method according to claim 31, wherein additives are incorporated into a material of the first layer and wherein the additives are vaporized thereby leaving behind pores within the first layer.

34. The method according to claim 31, wherein the first layer of the wear protection coating is applied by daubing, dipping or spraying as a slip material and is then hardened preferably by stove-enameling or aluminizing.

35. The method according to claim 31, wherein the first layer of the wear protection coating is applied with aid of a targeted matter vapor beam, in particular a PVD (Physical Vapor Deposition) matter beam.

36. The method according to claim 31, wherein the second layer is produced by evaporation coating or by nitration or by oxidizing or by aluminizing.

37. The method according to claim 36, wherein the second layer is applied directly to the first layer.

38. A gas turbine component, comprising:
a surface; and
a wear protection coating applied to the surface, wherein the wear protection coating includes a first layer in contact with the surface and having a material composition that is adapted to a material composition of the surface, and a second layer applied to the first layer that forms an outer cover coat on the component.

39. A method for wear protecting a component of a gas turbine, comprising the steps of:
applying a wear protection coating to a surface of the component, wherein the wear protection coating includes a first layer in contact with the surface and having a material composition that is adapted to a material composition of the surface, and a second layer applied to the first layer that forms an outer cover coat on the component.
